(19) United States
(12) Patent Application Publication
(10) Pub. No.: US 2025/0355501 A1
(43) Pub. Date: Nov. 20, 2025

(54) Gesture-Controlled Interactive Audio Adventure Application

(71) Applicant: SagaSwipe LLC, Venice, CA (US)

(72) Inventor: Joel Allred, Venice, CA (US)

(73) Assignee: SagaSwipe LLC, Venice, CA (US)

(21) Appl. No.: 18/666,907

(22) Filed: May 17, 2024

(51) Int. Cl. G06F 3/01

(52) U.S. Cl. CPC G06F 3/017

(57) ABSTRACT

An interactive and immersive adventure application instantiated on a user computing device is configured to receive gestures and responsively output audio descriptions. The adventure application may have pre-stored stories, maps, or virtual environments and generate stories, maps, or virtual environments on the fly using some artificial intelligence engine, such as an LLM (large language model) or a hybrid approach. The stories or maps may generally be referred to as an event structure. The adventure application can interoperate with a remote service that generates or receives the event structures, and the local adventure application can receive the event structures from the remote service. Alternatively, the user computing device's adventure application may have its own stories pre-downloaded or generated by a local LLM.

### BACKGROUND

In interactive adventures, users may select a storyline among several options they wish to explore. These existing systems are becoming rather conventional and dull, with little innovation for different use scenarios or implementations.

### SUMMARY

An interactive and immersive adventure application instantiated on a user computing device is configured to receive gestures and responsively output audio descriptions. The adventure application may have pre-stored stories, maps, or virtual environments and generate stories, maps, or virtual environments on the fly using some artificial intelligence engine, such as an LLM (large language model) or a hybrid approach. The stories or maps may generally be referred to as an event structure. The adventure application can interoperate with a remote service that generates or receives the event structures, and the local adventure application can receive the event structures from the remote service. Alternatively, the user computing device's adventure application may have its own stories pre-downloaded or generated by a local LLM.

The local adventure application presents a UI (user interface) that includes at least “start” and “stop” buttons and a joystick or other object that allows the user to manipulate a virtual persona. The start button may cause the adventure application to start the journey. The journey may be based on a randomly selected event structure, a generated story from an LLM, or some other event structure manually or automatically selected. In particular, the adventure application may receive descriptions for each directional joystick movement, such as forward, backward, left, right, diagonal direction, vertically up or down, etc. Thus, each direction is associated with a response. JSON (javascript object notation) may be used to ensure each directional movement has a corresponding description, e.g., “Left: [description].” However, other methods, such as XML, may also be used.

Upon the adventure's start, the user can control the storyline by moving the joystick in a direction. The joystick controls some virtual or conceptual character or persona within the event structure. So, for example, by the user pushing the joystick forward, the persona within the even structure moves accordingly. Responsively to the user selecting a directional movement with the joystick, the adventure application triggers an audio output that describes what the persona experiences when advancing in the selected direction. Experiences can include any of the human senses, such as sight, smell, touch, sound, and taste. Additionally, a look-around feature may be implemented by which the user can receive a description by leaning the joystick, in each direction, without actually moving the persona in that direction. So, the user can get a glimpse (or full understanding) of what each direction has to offer and then decide in which direction they want to travel.

The adventure application applicant may trigger the LLM each time the user moves in a direction to generate a new response for each directional movement with the joystick. So, the LLM may generate a response on the fly responsive to the user's directional input, or if the response is already pre-stored in local memory, then the LLM may generate subsequent responses for directional movements so that the application moves more fluidly.

While an LLM may be used, in other implementations, event structures may be pre-made for responses. For example, the persona may be placed on a map with distinct sections associated with certain descriptions. In this example, the event structure may be a map with sections broken up into boxes that the persona can traverse responsive to each directional movement. In some implementations, the LLM can be used in conjunction with some pre-made event structure to supplement and improve the output. Regardless of how the responses for directional movements are generated, a TTS (text-to-speech) engine can be used to read the generated text, such as from the LLM or pre-stored in the event structure.

### BRIEF DESCRIPTION OF THE DRAWINGS

FIG. 1 shows an illustrative user computing device downloading an adventure application from a remote application service;

FIGS. 2A-D show illustrative representations of various methods by which a user can interact with their computing device;

FIG. 3 shows an illustrative layered architecture of the user device that implements the adventure application;

FIG. 4 shows an illustrative user interface (UI) for the adventure application;

FIG. 5 shows an illustrative UI in which a joystick is pushed upward;

FIG. 6 shows an illustrative UI in which the user taps the ‘Start’ button;

FIG. 7 shows an illustrative schematic representation in which an event structure is created for an instance of the adventure application;

FIG. 8 shows an illustrative representation of the user device outputting descriptions from the event structure using text-to-speech (TTS);

FIG. 9 shows an illustrative representation of the user device outputting descriptions responsive to the user moving the adventure application's persona in a direction;

FIG. 10 shows an illustrative representation of each directional movement being associated with a description for the user device to output;

FIG. 11 shows an illustrative representation in which the LLM (large language model) is applied to the event structure at a given instance;

FIG. 12 shows an illustrative representation of the LLM being applied to the full or partial maps to enhance or supplement them;

FIG. 13 shows an illustrative conceptual representation of the user's persona placed within an even structure of the adventure application;

FIG. 14 shows an illustrative conceptual representation of the user's persona moving in a forward direction responsive to user input and the user device outputting the associated description;

FIG. 15 shows an illustrative conceptual representation of the user's persona traversing multiple steps, each responsive to some user input;

FIG. 16 shows an illustrative schematic representation of one or both of the event structure or LLM outputting various sensory information with the descriptions for each step;

FIG. 17 shows an illustrative representation of a glimpse feature whereby the user device outputs a partial or full description in a direction in which the user provides some modified input into the adventure application

FIGS. 18-19 show illustrative processes performed by any one or more of the user computing device or remote service;

FIG. 20 shows a simplified block diagram of a computing device that may be used to implement the present gesture-controlled interactive audio adventure application; and

FIG. 21 shows a simplified block diagram of a computing device that may be used to implement the present gesture-controlled interactive audio adventure application.

Like reference numerals indicate like elements in the drawings. Elements are not drawn to scale unless otherwise indicated.

### DETAILED DESCRIPTION

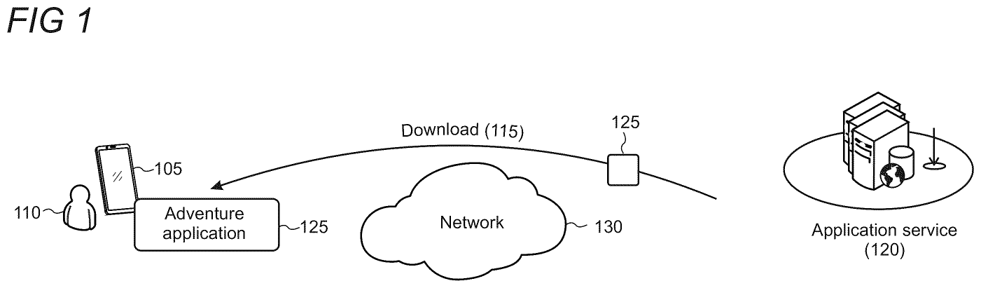

FIG. 1 shows an illustrative environment in which a user computing device 105, such as a smartphone operated by a user 110, accesses an application service 120 to download an adventure application 125. The user device 105 accesses the remote application service over a network 130, which can include any one or more of a local area network, wide area network, the Internet, or the world wide web. The user device may access an application store that enables them to find and select the application they wish to download 115 to their device.

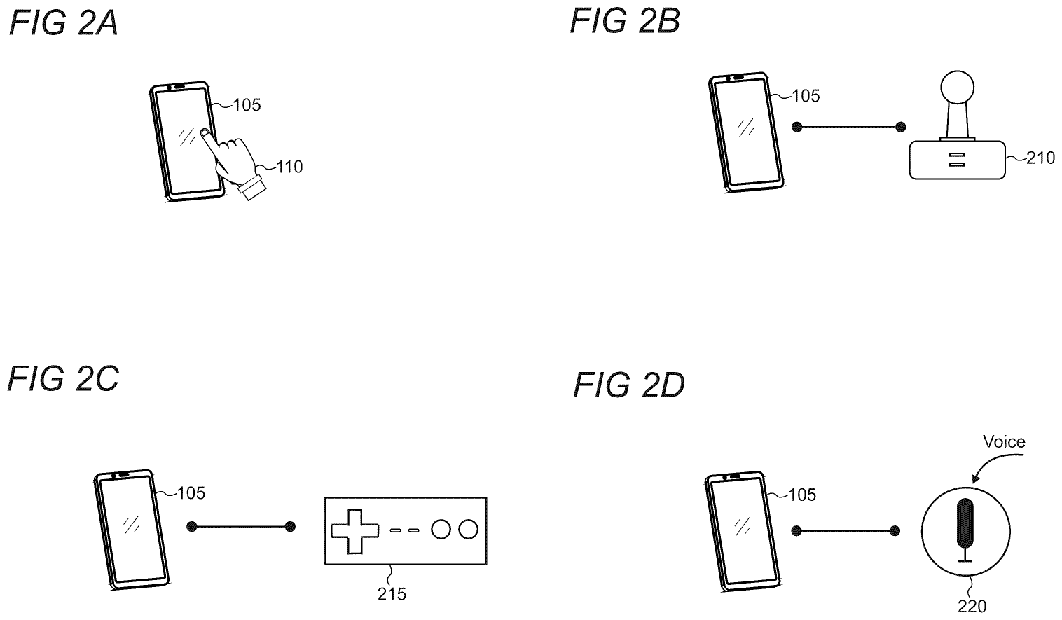

FIGS. 2A-D show illustrative representations in which various user interfaces (UIs) can be utilized by the user to interact with the user device 105. For example, the user 110 can use their hand with a touchscreen display, a joystick 210 that has a wired or wireless connection to the device, such as using Bluetooth® or NFC (near field communication), a controller 215, or a microphone 220. Any one or more of these UIs can be utilized to communicate with the user device and the adventure application 125.

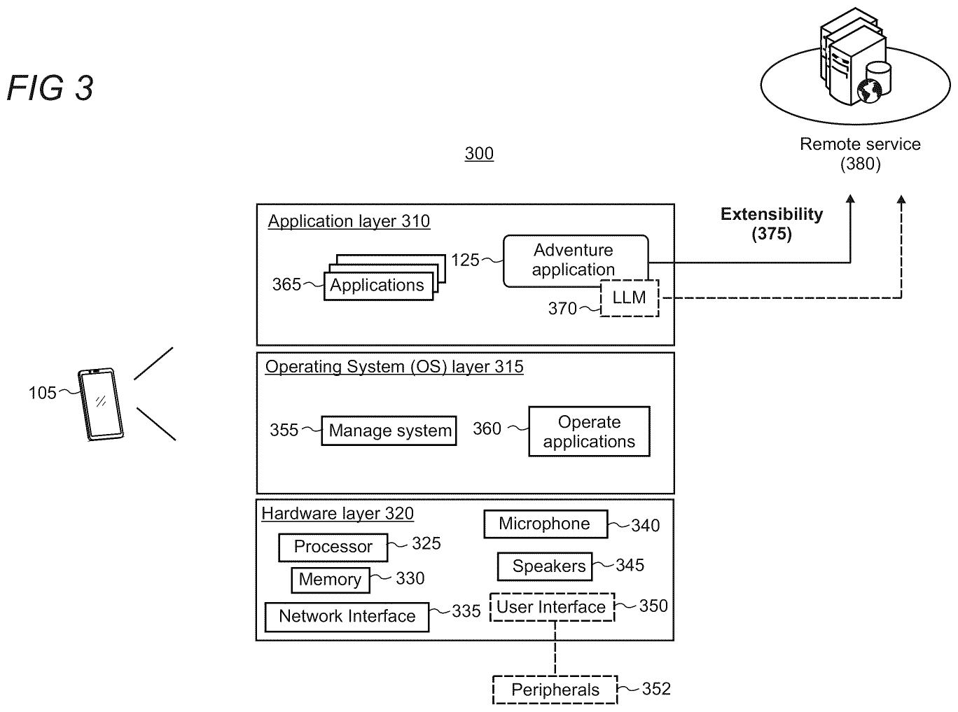

FIG. 3 shows a simplified layered architecture 300 of a user device 105, such as a mobile device, smartphone, tablet, laptop, etc., that may implement the features described herein.

The user device 105 can include a hardware layer 320, operating system (OS) layer 315, and application layer 310. The hardware layer 320 provides an abstraction of the various hardware used by the device 105 (e.g., input and output devices, networking and radio hardware, etc.) to the layers above it. In this illustrative example, the hardware layer supports processor(s) 325, memory 330, and a network interface 335, such as a network interface card (NIC), enabling a wireless connection to the Internet. The network interface may work with a cellular connection to a cell tower or utilize Wi-Fi to connect to the Internet. Various input/output devices may be utilized, such as a microphone 340, speakers 345, and other user interfaces 350 that leverage peripheral devices 352, such as a headset.

The application layer 310 in this illustrative example supports various applications 365, including the adventure application 125, that utilizes or interacts with an LLM (large language model) component 370. Although the various applications are depicted as standalone applications in FIG. 3, the applications may alternatively operate within the same application, as a plugin to other applications or the OS, or interoperate with remotely executing code, such as with the remote service 380. The remote service 380 may be leveraged by the adventure application to support the adventure application's functions. For example, at least some features or functions discussed herein may be performed by the remote service, such as the creation or storage of event structures, as discussed in greater detail below. The LLM may additionally or alternatively be instantiated on the remote service, and actions and data are transmitted from the remote service to the local adventure application.

Large Language Models are advanced artificial intelligence systems that can understand, interpret, and generate human-like text. They are typically trained on massive datasets containing billions or trillions of words from the internet and other sources. LLMs use deep learning techniques, such as transformer neural networks, to analyze and learn patterns in the training data. This allows them to develop an understanding of how words relate to each other and how to construct coherent sentences and paragraphs. After initial training on broad datasets, LLMs can be further fine-tuned on more specific tasks like question-answering, text generation (as done herein), translation, code writing, and analysis of data like DNA sequences.

Although only certain applications are depicted in FIG. 1, the user device 105 can utilize any number of applications 365. The applications are often implemented using locally executing code. In some cases, however, these applications can rely on services and/or remote code execution provided by remote servers or other computing platforms, such as those supported by a service provider or other cloud-based resources (not shown). The user device may be configured with extensibility 375 to the remote service 380 or other computing devices, such as by using its network interface 335. Furthermore, the remote service 380 may be configured with an adventure application 125 that is utilized to manage and handle certain processes discussed herein.

The OS layer 315 supports, among other operations, managing system 355 and operating applications/programs 360. The OS layer may interoperate with the application and hardware layers in order to perform various functions and features.

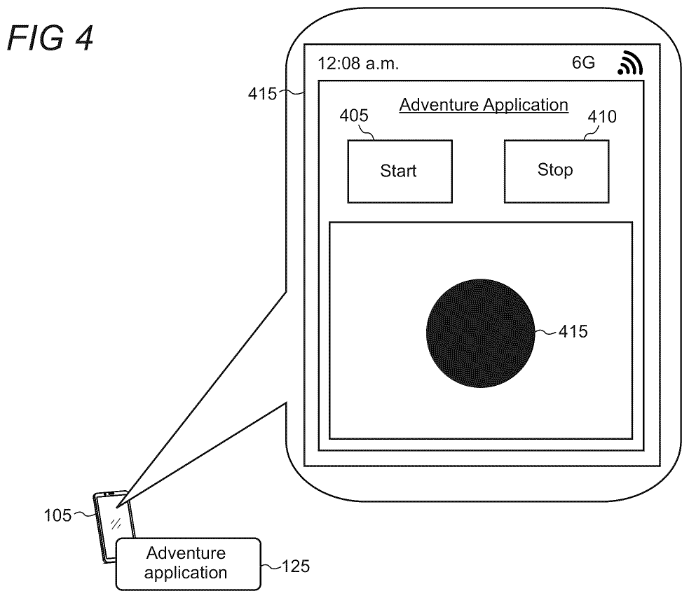

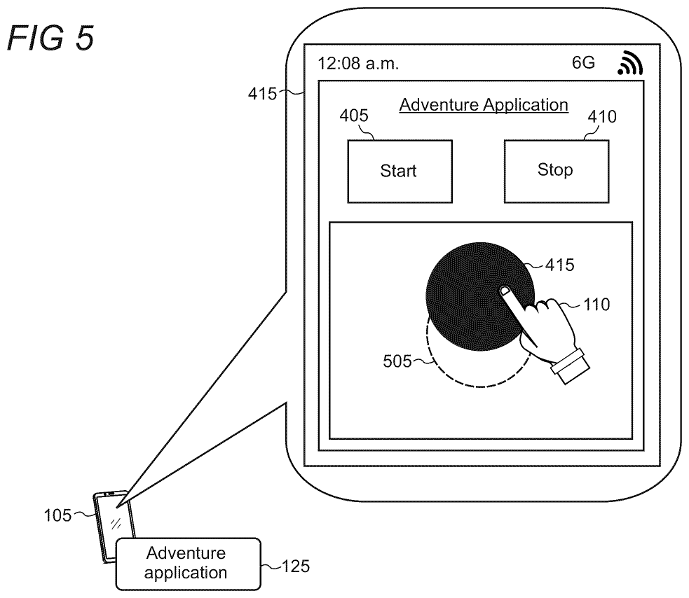

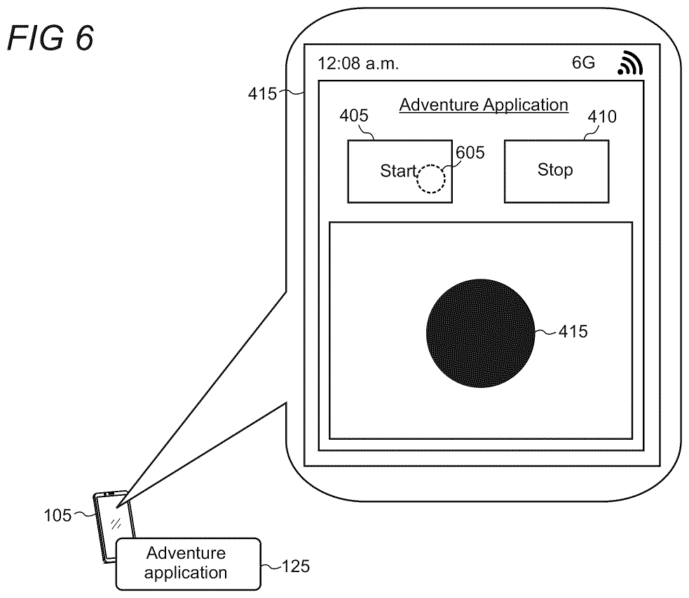

FIG. 4 shows an illustrative user interface (UI) 415 associated with the user computing device 105 for the adventure application 125. The UI includes a start 405 and stop 410 buttons that the user can press while using the application. In other implementations, a single start/stop button that functions like a play/pause button may be used. The UI includes a virtual joystick 415 with which the user can interact. For example, FIG. 5 shows an illustrative UI in which the user 110 moves the joystick 415 in an upward direction, as shown by the static position 505 below it. Moving the joystick in a direction controls a virtual persona that traverses through a virtual world or map within the adventure application. FIG. 6 shows an illustrative representation in which the user selects the start button 405 via some input mechanism, such as a touch on a touchscreen display of the UI 415. While input at a touchscreen display is shown and discussed herein, any UI that can interact with the adventure application is also possible, such as those shown in FIGS. 2A-D. Exemplary UIs that can control the operations of the adventure application 125 can include a keyboard, mouse or pointing device, joystick, gaming controller, voice controls using a microphone, etc.

Alternatively, swipes or taps on the screen may be utilized for directional movements. In this regard, there may be no observable controller on the UI, but rather the entire adventure application UI itself is the operable controller that reacts to directional swipes or user taps. For example, one tap may cause a forward movement, two taps cause a rear movement, etc. Adjusting the timing or duration of taps also, such as ‘a long press, long press, short press’ may cause a right movement. Touching specific spots on the touchscreen's UI may also cause directional movements, such as touching the upper portion of a defined area on the application may cause a forward movement.

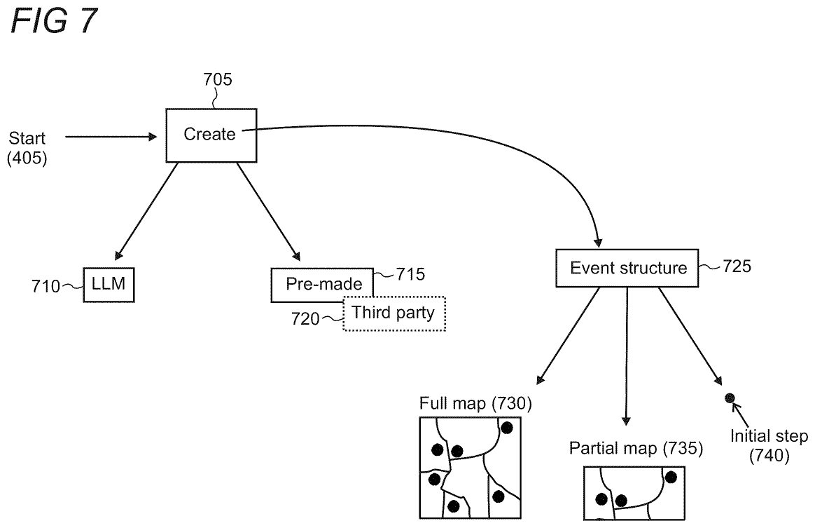

FIG. 7 shows an illustrative schematic representation in which the adventure application 125 creates 705 an event structure 725 that is then used as a basis for a user 110 traversing through a virtual story or world. The event structure may be created responsive to the user tapping the start button 405 or may already be created before the user starts the journey. The created event structure may be achieved from an LLM (large language model) 710, be pre-made 715, such as by a third party 720 or the application's creators, or a hybrid approach.

Thus, the virtual world or story may be created solely by an LLM 710 or may be partially or fully created or stored for future use, which may be supplemented or enhanced by the LLM, or alternatively, the pre-made version may be used by itself. Thus, the event structure that is created may be a full map 730, partial map 735, or a single initial step 740. The full map signifies that the entire story or world is created for user traversal using the joystick 415. The partial map may be a portion of the world or a story created. The initial step may be, for example, that the first instance or step in the world is created, but beyond that, the LLM creates any future subsequent steps responsive to the user's movement input at the joystick. In scenarios in which the full or partial map is created, the LLM may still supplement or enhance the stores or worlds. For example, the LLM may add other descriptions, such as other sensory information. This may occur after the user traverses the world using the joystick.

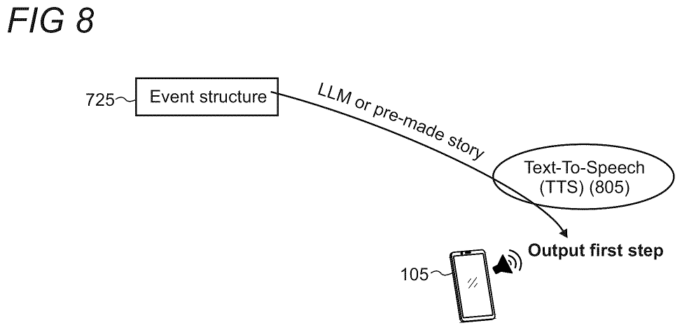

FIG. 8 shows an illustrative representation in which a text-to-speech (TTS) 805 engine is used to output the event structure's descriptions. The TTS engine may output LLM-created descriptions, pre-made descriptions, or a hybrid of both, depending on the implementation. Thus, the LLM can create the story, and the TTS engine outputs it for user consumption.

In some implementations, the TTS engine 805 may be remote or locally executing. The TTS engine may operate as part of the remote service 380, or on its own dedicated server. The generated descriptions, whether from the LLM or user-created, may be transmitted to the TTS engine on its server for processing into audible speech, which is then transmitted to the user's computing device 105 for output.

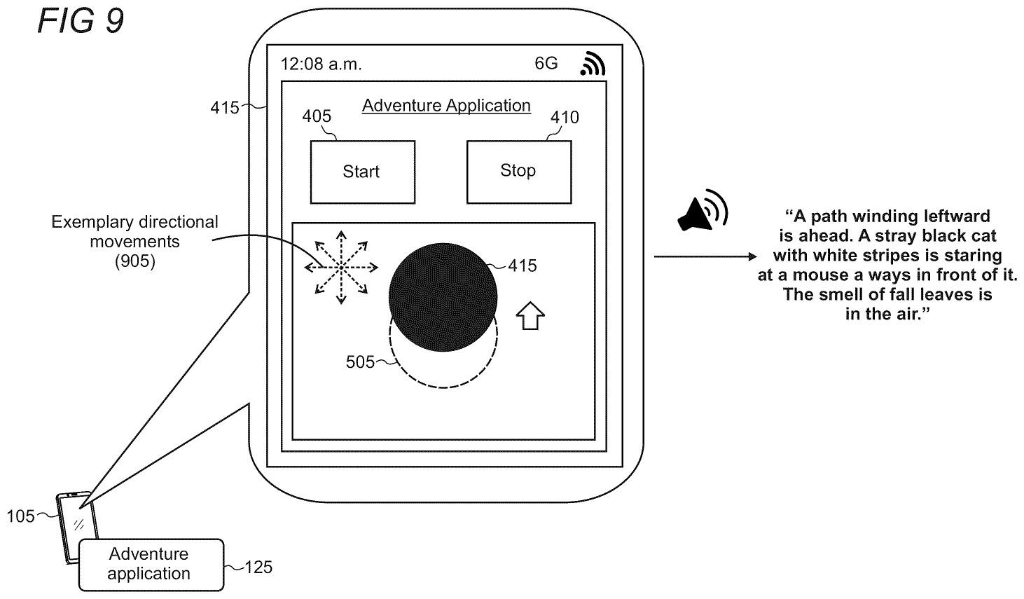

FIG. 9 shows an illustrative representation in which the user device 105 outputs, via speakers 345 (FIG. 3), a description of the virtual world responsive to a virtual persona's movement therein when the user manipulates the joystick 415 in a direction. The user moves the joystick upward, which causes the persona within the virtual world to move in an upward direction, thereby causing the adventure application to either generate or retrieve the associated description with that movement. In this regard, each directional movement may be associated with a unique description, which is then output responsive to the user's directional control. FIG. 9 shows exemplary directional movements that may be deployed by the adventure application 125, but other directional movements may also be possible, such as downward crouching, upward jumping or flying, etc.

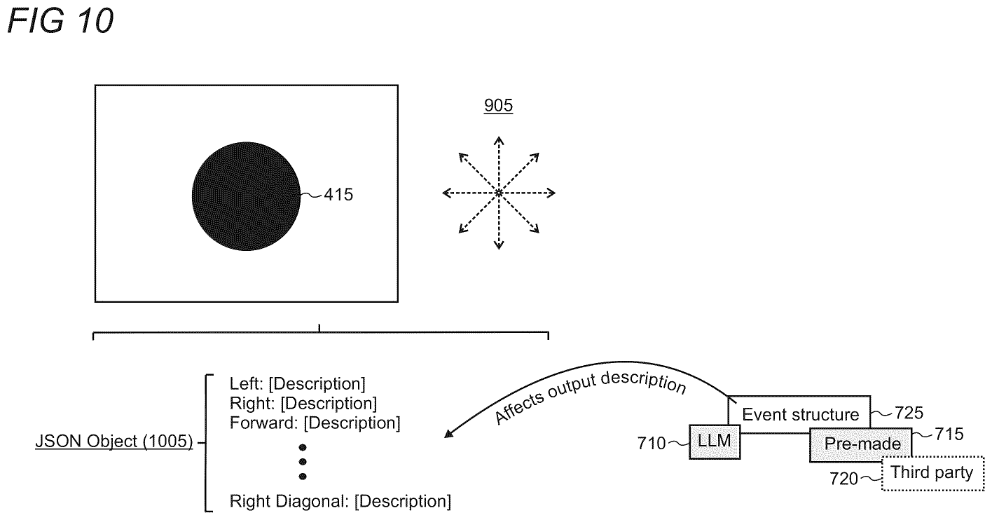

FIG. 10 shows an illustrative representation in which the adventure application 125 is programmed to associate specific directional movements with descriptions. In some implementations, this may be accomplished using a JSON (javascript object notation) object 1005; this way, the user always receives some feedback when they select a particular directional movement. JSON may be utilized regardless of where the main story processing and generation is performed, e.g., on the local user device 105 or the remote service 380 (FIG. 3). JSON is used so each direction has an associated description. Other data formats may also be used, such as XML (extensible markup language), YAML, Markdown, among other data formats. As shown in FIG. 10, the event structure's 725 associated descriptions are based on the LLM 710 or pre-made stories or virtual worlds 715. When an LLM is used, those descriptions are updated once the LLM creates a description for each direction. When pre-made stories are used, those may be input into the descriptions based on the user's current position. In this regard, for pre-made virtual worlds or stories, descriptions are associated with specific locations on the map for each specific direction. Even if a pre-made world or story is used, the LLM may still be used to supplement or enhance that pre-made world's or story's descriptions, such as providing additional descriptions to what was already pre-made.

The event structure 725, including previously generated and output descriptions within a given adventure session, affects future descriptions for directional movements. The LLM may be configured in various ways to accomplish coherency, sense, and consistency within a given adventure session for descriptions. For example, the LLM may continuously store and leverage previously generated and output descriptions to ensure that future output descriptions for directional movements are consistent with previous ones. The LLM may be configured to build on top of prior descriptions for a given session (stateful). Different sessions, such as after the user taps the “stop” button, may be unaware of (stateless) previous sessions to avoid merging or affecting unconnected stories and sessions. Alternatively or additionally, the LLM may continuously digest all previously generated and output descriptions before each generated description; this way any generated and output descriptions are coherent and consistent with prior ones. In short, the LLM may be stateful or stateless, and the present implementation can leverage either LLM configuration for efficacy.

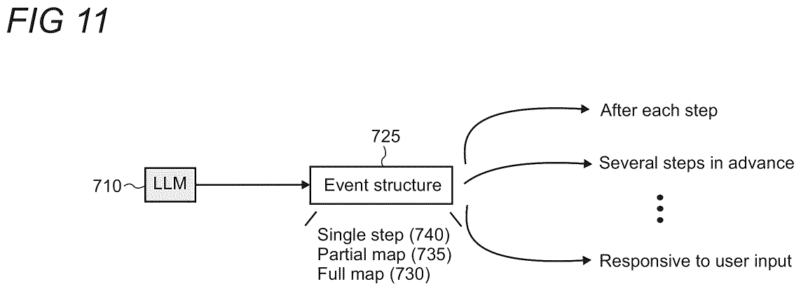

FIG. 11 shows an illustrative representation in which the LLM 710 can create the event structure 725 at given times. For example, the LLM may create the next set of directional descriptions after each step, several steps in advance (e.g., 2-4 steps in advance), or immediately responsive to the user's directional input (e.g., a left movement on the joystick). Such creations by the LLM can occur whether the event structure is created of a single step 740, partial map 735, or full map 730.

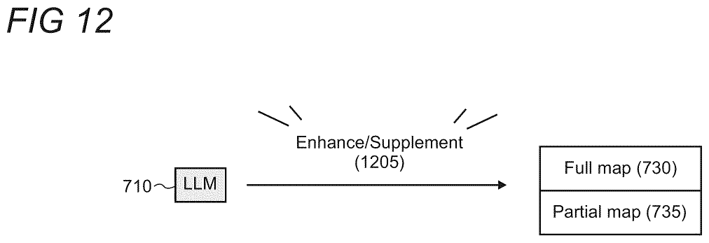

FIG. 12 shows an illustrative representation in which the LLM can enhance or supplement 1205 the full map 730 or partial map 735. For example, if a virtual world or story is already created for use, either by the application's creator or uploaded by a third party, the LLM may still be leveraged to supplement or enhance the partially or fully created worlds and stories. The LLM may, for example, add other sensory observations viewed in the virtual world, such as smell, taste, or any other information that enhances the pre-created world.

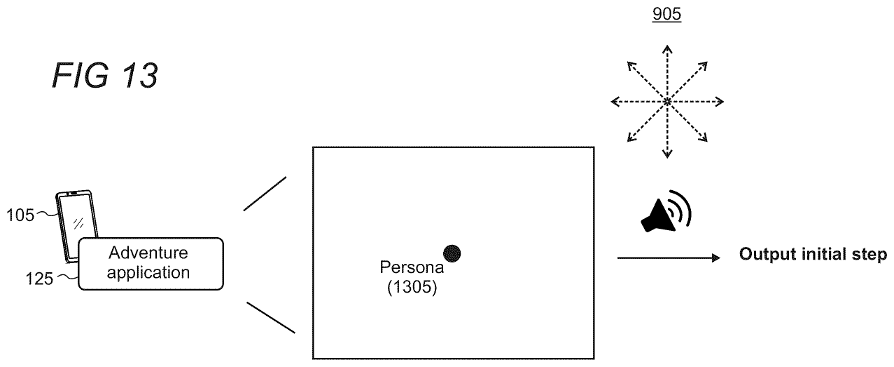

FIG. 13 shows an illustrative conceptual representation in which the virtual persona 1305 is within a virtual world of the adventure application 125. This may occur when, for example, the user selects the start button 405 (FIG. 6). Upon the persona entering the virtual world and the application initiating, the adventure application may already start to output descriptions associated with that initial step. The description may be pre-made or generated by the LLM.

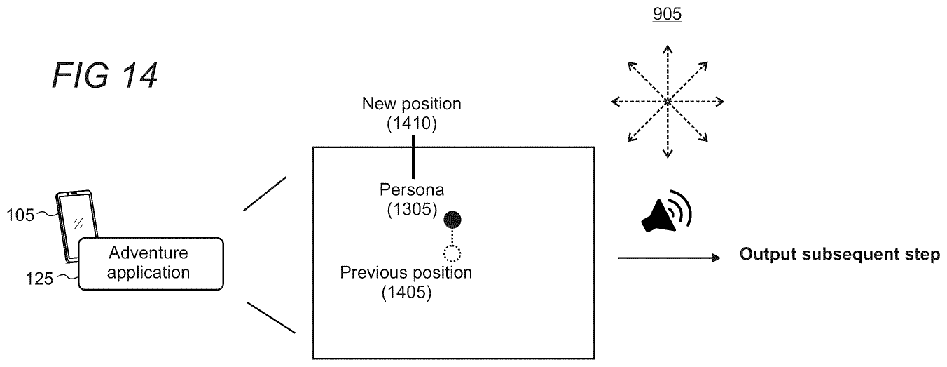

FIG. 14 shows an illustrative representation in which the persona 1305 traverses in a forward direction responsive to the user's directional input, an upward push on the joystick 415. The user's previous position 1405 is shown to illustrate the user's new and current position 1410. Responsive to this move, the adventure application then outputs the world's description based on the user's subsequent traversal through the virtual world. This description may be pre-made, generated via the LLM, or a hybrid approach. The TTS engine (FIG. 8) is utilized to output the description. For the outputs in FIGS. 13 and 14, such functions may be performed locally at the user device 105, remotely by the remote service 380, or some hybrid approach. For example, a remotely executing LLM may generate the descriptions responsive to the user's directional movement or may generate the response in advance and transmit those descriptions to the user's device. Such pre-generation and transmission to the user's device may streamline the application's performance and reduce delay or lag.

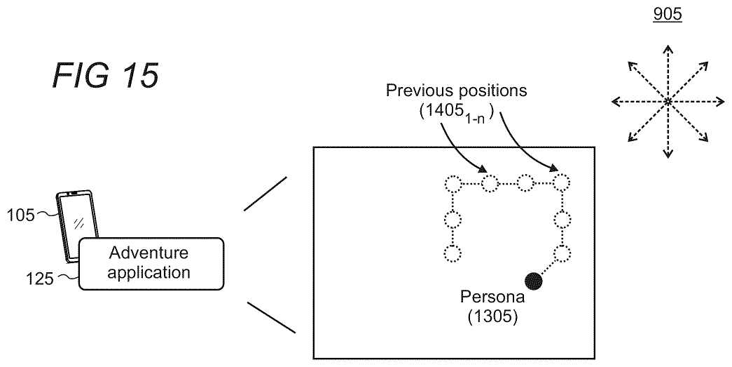

FIG. 15 shows an illustrative representation in which the user 110 can continue controlling the adventure application's joystick 415 to traverse the persona 1305 throughout the virtual world. At each step, the process repeats itself, and new descriptions are generated based on the user's position in the virtual world. The various output descriptions may be generated on the fly by the LLM, pre-made, or a hybrid approach. The output story's descriptions will typically tie in with the previous steps' outputs so that the story is ongoing and rational. If the user moves in some circle and lands in a previously traversed spot in the virtual world, then one would expect the LLM or pre-made story to recognize such an event and re-output the previously used descriptions.

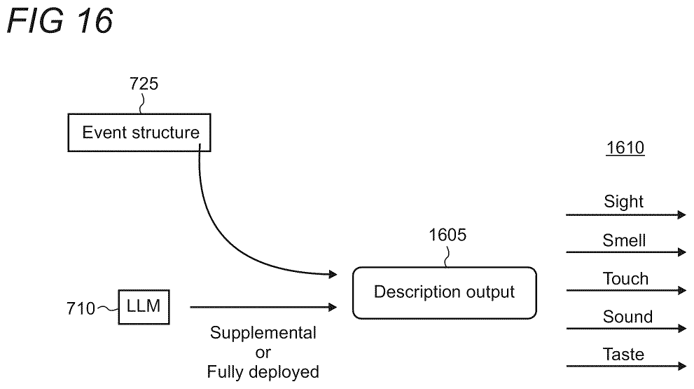

FIG. 16 shows an illustrative representation in which the event structure's description output 1605 can include any one or more of the human senses 1610, including sight, smell, touch, sound, or taste. Thus, descriptions may include any one or more of these. Furthermore, the LLM 710 may generate and provide such descriptions for the event structure 725, whether the LLM is fully deployed or supplemental to a partially or fully developed map.

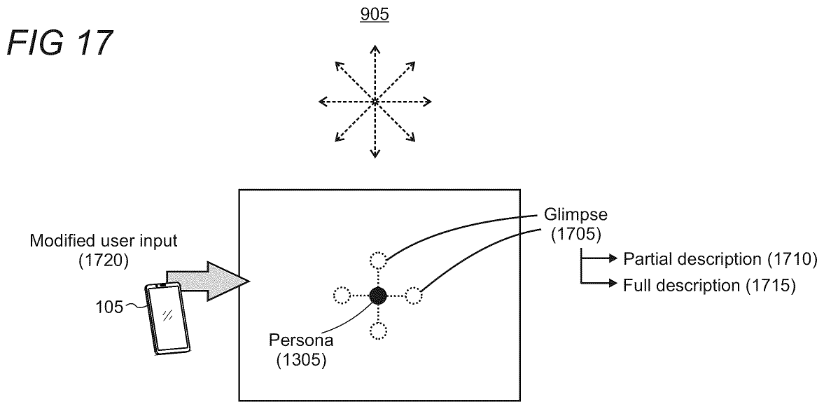

FIG. 17 shows an illustrative representation in which a modified user input 1720 at the adventure application 125 can provide a glimpse 1705 into a given directional movement. A modified user input can include, for example, the user pressing and holding the joystick in a given direction and then moving the joystick back to the center position so that the persona does not move in that direction. Other modified inputs may be an additional button to press, double-clicking, fast swiping, etc. The glimpse can include either a partial description 1710 or a full description 1715 for the description associated with the direction. The output glimpse may either output the set glimpse description or may continue to output the description until the user provides some canceling input, such as dragging the joystick back to a center position, tapping the screen in a certain manner, etc.

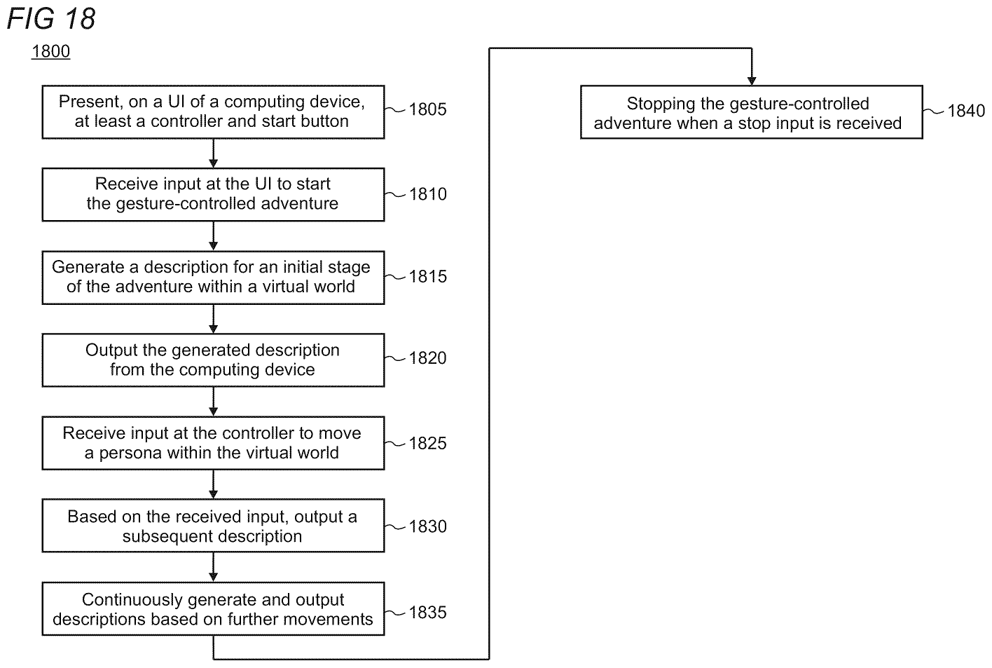

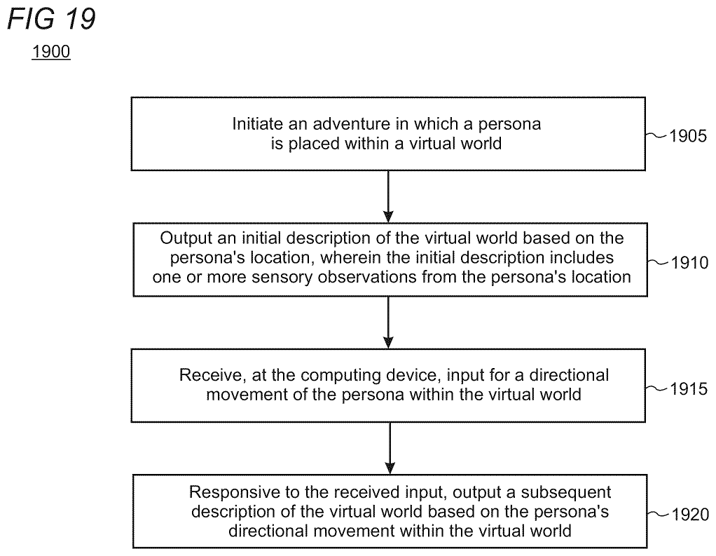

FIGS. 18 and 19 are flowcharts of exemplary methods 1800, 1900 that may be implemented by one or more of a computing device or remote service. Unless specifically stated, the methods or steps shown in the flowcharts and described in the accompanying text are not constrained to a particular order or sequence. In addition, some of the methods or steps thereof can occur or be performed concurrently, and not all the methods or steps have to be performed in a given implementation depending on the requirements of such implementation, and some methods or steps may be optionally utilized.

In step 1805, in FIG. 18, a computing device presents on its UI (user interface) at least a controller and a start button. The controller may be a joystick or other input mechanism that allows a user to provide input into an adventure application and control a persona within the application's virtual world. Such input may be done via the device's touchscreen display. Other controllers may be periphery devices connected to the computing device, such as an external hardware controller. The start button initiates the gesture-controlled adventure. In step 1810, the adventure application receives an input from its UI to start the gesture-controlled adventure. In step 1815, the computing device or a remote service in communication with the computing device generates a description for an initial stage of the adventure within a virtual world. The initial description may be generated on the fly responsive to the start button or may be generated prior to the user starting the journey. The initial description may be human-made, generated by an LLM, or some hybrid approach. For example, the computing device or remote service may pre-generate stories and descriptions to reduce delay by the local application.

In step 1820, the computing device outputs the generated description, such as through its speakers, a headset, etc. In this regard, the generated description may be written material that is then read via a text-to-speech (TTS) engine, for example. In step 1825, the adventure application receives input from its controller (e.g., joystick) to move a persona within the virtual world in some direction, such as forward, back, left, right, diagonal, etc. In step 1830, based on the received directional input, the computing device outputs a subsequent description associated with the virtual persona's current and new location. In this regard, the application may associate specific descriptions with specific directional movements to make the story realistic. Such generated and associated descriptions should be sensical relative to prior outputs by the device. Thus, prior output or generated descriptions may be used by future generated descriptions, such as by the LLM, so that the story is fluid and to reduce the possibility for inconsistencies. For example, if the generated descriptions reference moving forward advances to Los Angeles, then it would likely be an inconsistency for continued forward movements to reference New York.

In step 1835, the adventure application continuously generates and outputs descriptions based on further directional movements. Thus, after each new directional input, further descriptions will be generated and output to users. While descriptions are described as being generated, in some scenarios, the outputs may already be pre-generated or made within the virtual world. In that regard, the system may output what was already made or may supplement or enhance the pre-made descriptions using the LLM. For example, the LLM may digest the pre-made descriptions and then modify or add to them using its capabilities. In step 1840, the computing device stops the gesture-controlled adventure responsive to receiving a stop input from the user. The stop input may come, for example, when the user selects a stop button on the UI.

In step 1905, in FIG. 19, a computing device initiates an adventure in which a persona is placed within a virtual world. The virtual world may be fully or partially developed at the start of the adventure. For example, at a minimum, a persona is created and is tied to a description that is one or both of pre-made or generated from an LLM or third party. This description is then output as the beginning of the virtual world. In step 1910, the computing device outputs an initial description of the virtual world based on the persona's location, wherein the initial description includes one or more sensory observations from the persona's location. In step 1915, the computing device receives input for a directional movement of the persona within the virtual world. Such a directional movement input can include moving forward, back, left, right, diagonal, vertically upward or down, flying, etc. In step 1920, the computing device, responsive to receiving the input for the directional movement, outputs a subsequent description of the virtual world based on the persona's directional movement within the virtual world.

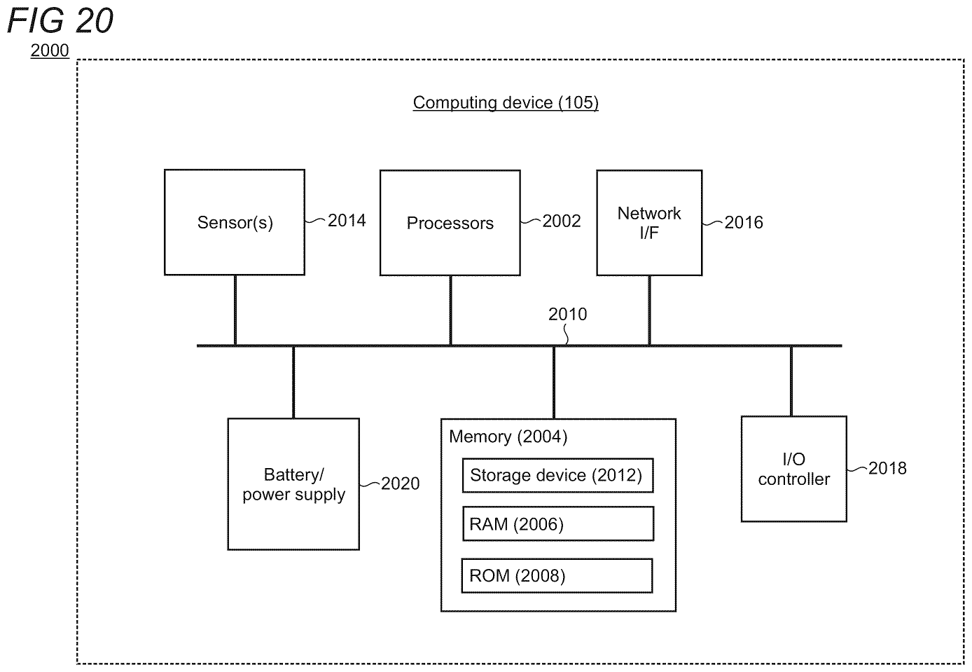

FIG. 20 shows an illustrative architecture 2000 for a computing device 105 capable of executing the various features described herein. The architecture 2000 illustrated in FIG. 20 includes one or more processors 2002 (e.g., central processing unit, dedicated AI chip, graphics processing unit, etc.), a system memory 2004, including RAM (random access memory) 2006, ROM (read-only memory) 2008, and long-term storage devices 2012. The system bus 2010 operatively and functionally couples the components in the architecture 2000. A basic input/output system containing the basic routines that help to transfer information between elements within the architecture 2000, such as during start-up, is typically stored in the ROM 2008. The architecture 2000 further includes a long-term storage device 2012 for storing software code or other computer-executed code that is utilized to implement applications, the file system, and the operating system. The storage device 2012 is connected to processor 2002 through a storage controller (not shown) connected to bus 2010. The storage device 2012 and its associated computer-readable storage media provide non-volatile storage for the architecture 2000. Although the description of computer-readable storage media contained herein refers to a long-term storage device, such as a hard disk or CD-ROM drive, it may be appreciated by those skilled in the art that computer-readable storage media can be any available storage media that can be accessed by the architecture 2000, including solid-state drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 2000.

According to various embodiments, the architecture 2000 may operate in a networked environment using logical connections to remote computers through a network. The architecture 2000 may connect to the network through a network interface unit 2016 connected to the bus 2010. It may be appreciated that the network interface unit 2016 may also be utilized to connect to other types of networks and remote computer systems. The architecture 2000 also may include an input/output controller 2018 for receiving and processing input from a number of other devices, including a keyboard, mouse, touchpad, touchscreen, control devices such as buttons and switches or electronic stylus (not shown in FIG. 20). Similarly, the input/output controller 2018 may provide output to a display screen, user interface, a printer, or other type of output device (also not shown in FIG. 20).

It may be appreciated that any software components described herein may, when loaded into the processor 2002 and executed, transform the processor 2002 and the overall architecture 2000 from a general-purpose computing system into a special-purpose computing system customized to facilitate the functionality presented herein. The processor 2002 may be constructed from any number of transistors or other discrete circuit elements, which may individually or collectively assume any number of states. More specifically, the processor 2002 may operate as a finite-state machine, in response to executable instructions contained within the software modules disclosed herein. These computer-executable instructions may transform the processor 2002 by specifying how the processor 2002 transitions between states, thereby transforming the transistors or other discrete hardware elements constituting the processor 2002.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in architecture 2000 in order to store and execute the software components presented herein. It also may be appreciated that the architecture 2000 may include other types of computing devices, including wearable devices, handheld computers, embedded computer systems, smartphones, PDAs, and other types of computing devices known to those skilled in the art. It is also contemplated that the architecture 2000 may not include all of the components shown in FIG. 20, may include other components that are not explicitly shown in FIG. 20, or may utilize an architecture completely different from that shown in FIG. 20. The one or more sensors 2014 can include any number of sensors that enable a plunger lift to pick up data about plunger lift operations. These include the sensors, for example, shown and described in FIG. 4.

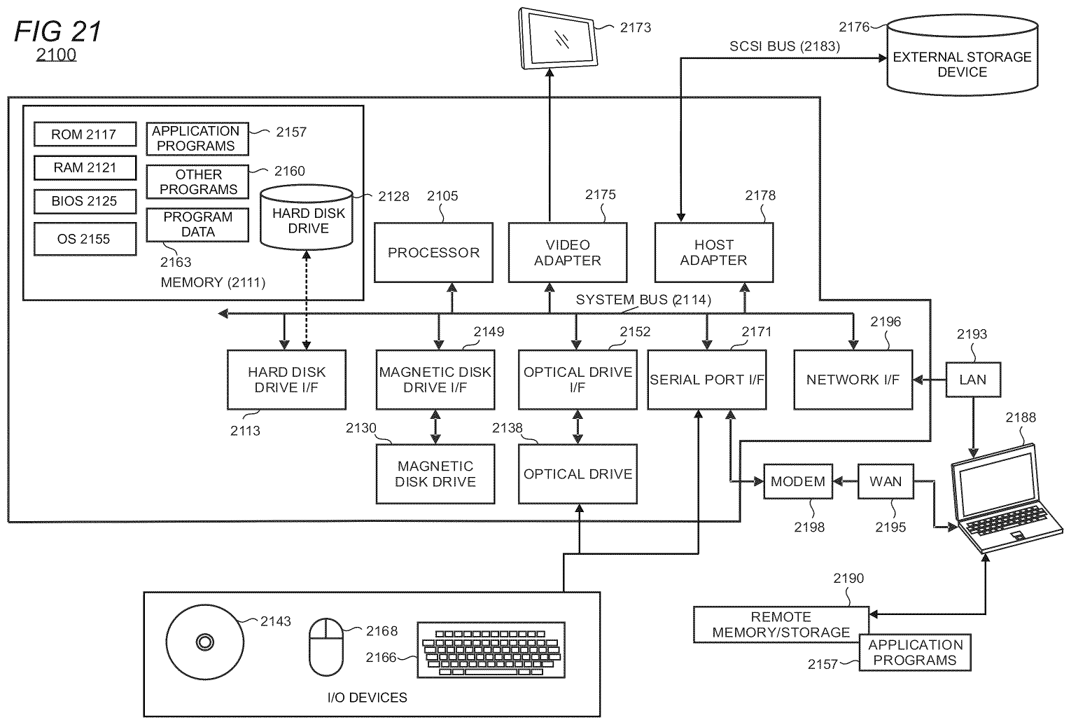

FIG. 21 is a simplified block diagram of an illustrative computer system 2100 such as a remote server (e.g., remote service 380), smartphone, tablet computer, laptop computer, or personal computer (PC), which the present disclosure may be implemented. Computer system 2100 includes a processor 2105, a system memory 2111, and a system bus 2114 that couples various system components, including the system memory 2111 to the processor 2105. The system bus 2114 may be any of several types of bus structures, including a memory bus or memory controller, a peripheral bus, or a local bus using any of a variety of bus architectures. The system memory 2111 includes read-only memory (ROM) 2117 and random access memory (RAM) 2121. A basic input/output system (BIOS) 2125, containing the basic routines that help to transfer information between elements within the computer system 2100, such as during start-up, is stored in ROM 2117. The computer system 2100 may further include a hard disk drive 2128 for reading from and writing to an internally disposed hard disk, a magnetic disk drive 2130 for reading from or writing to a removable magnetic disk (e.g., a floppy disk), and an optical disk drive 2138 for reading from or writing to a removable optical disk 2143 such as a CD (compact disc), DVD (digital versatile disc), or other optical media. The hard disk drive 2128, magnetic disk drive 2130, and optical disk drive 2138 are connected to the system bus 2114 by a hard disk drive interface 2146, a magnetic disk drive interface 2149, and an optical drive interface 2152, respectively. The drives and their associated computer-readable storage media provide non-volatile storage of computer-readable instructions, data structures, program modules, and other data for the computer system 2100. Although this illustrative example includes a hard disk, a removable magnetic disk 2133, and a removable optical disk 2143, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present disclosure. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, are intended to cover non-transitory embodiments, and does not include waves, signals, and/or other transitory and/or intangible communication media.

A number of program modules may be stored on the hard disk, magnetic disk, optical disk 2143, ROM 2117, or RAM 2121, including an operating system 2155, one or more application programs 2157, other program modules 2160, and program data 2163. A user may enter commands and information into the computer system 2100 through input devices such as a keyboard 2166, pointing device (e.g., mouse) 2168, or touchscreen display 2173. Other input devices may include a microphone, joystick, game pad, satellite dish, scanner, trackball, touchpad, touch-sensitive device, voice-command module or device, user motion or user gesture capture device, or the like. These and other input devices are often connected to the processor 2105 through a serial port interface 2171 that is coupled to the system bus 2114, but may be connected by other interfaces, such as a parallel port, game port, or universal serial bus (USB). A monitor 2173 or other type of display device is also connected to the system bus 2114 via an interface, such as a video adapter 2175. In addition to the monitor 2173, personal computers typically include other peripheral output devices (not shown), such as speakers and printers. The illustrative example shown in FIG. 21 also includes a host adapter 2178, a Small Computer System Interface (SCSI) bus 2183, and an external storage device 2176 connected to the SCSI bus 2183.

The computer system 2100 is operable in a networked environment using logical connections to one or more remote computers, such as a remote computer 2188. The remote computer 2188 may be selected as another personal computer, a server, a router, a network PC, a peer device, or other common network node, and typically includes many or all of the elements described above relative to the computer system 2100, although only a single representative remote memory/storage device 2190 is shown in FIG. 21. The logical connections depicted in FIG. 21 include a local area network (LAN) 2193 and a wide area network (WAN) 2195. Such networking environments are often deployed, for example, in offices, enterprise-wide computer networks, intranets, and the Internet.

When used in a LAN networking environment, the computer system 2100 is connected to the local area network 2193 through a network interface or adapter 2196. When used in a WAN networking environment, the computer system 2100 typically includes a broadband modem 2198, network gateway, or other means for establishing communications over the wide area network 2195, such as the Internet. The broadband modem 2198, which may be internal or external, is connected to the system bus 2114 via a serial port interface 2171. In a networked environment, program modules related to the computer system 2100, or portions thereof, may be stored in the remote memory storage device 2190. It is noted that the network connections shown in FIG. 21 are illustrative and other means of establishing a communications link between the computers may be used depending on the specific requirements of an application of the present disclosure.

Various exemplary embodiments are disclosed herein. In one exemplary embodiment, implemented is a computing device, comprising: one or more processors; one or more hardware-based memory devices storing computer-executable instructions which, when executed by the one or more processors, cause the computing device to: initiate an adventure in which a persona is placed within a virtual world; output an initial description of the virtual world based on the persona's location, wherein the initial description includes one or more sensory observations from the persona's location; receive, at the computing device, input for a directional movement of the persona within the virtual world; and responsive to the received input, output a subsequent description of the virtual world based on the persona's directional movement within the virtual world.

In another example, the subsequent description changes based on the specific directional movement associated with the received input. As another example, descriptions for each available directional movement are pre-assigned prior to the received input. In a further example, the output initial description is generated from an LLM (large language model). As another example, the output subsequent description is likewise generated from the LLM. As another example, the virtual world is a mix of user-created and LLM-created. As another example, descriptions are directed to one or more of a human's senses.

In another exemplary embodiment, disclosed is a method performed by a computing device, comprising: initiating an adventure in which a persona is placed within a virtual world; outputting an initial description of the virtual world based on the persona's location, wherein the initial description includes one or more sensory observations from the persona's location; receiving, at the computing device, input for a directional movement of the persona within the virtual world; and responsive to the received input, outputting a subsequent description of the virtual world based on the persona's directional movement within the virtual world, wherein the initial and subsequent descriptions are received at the computing device from a remote service.

In a further example, the subsequent description changes based on the specific directional movement associated with the received input. As another example, descriptions for each available directional movement are pre-assigned prior to the received input. As another example, the output initial description is generated from an LLM (large language model). As another example, the output subsequent description is likewise generated from the LLM. As another example, the virtual world is a mix of user-created and LLM-created. As another example, descriptions are directed to one or more of a human's senses.

In another exemplary embodiment, disclosed are one or more hardware-based non-transitory computer-readable memory devices storing computer-executable instructions which, when executed by one or more processors disposed in a computing device, causes the computing device to: initiate an adventure in which a persona is placed within a virtual world; output an initial description of the virtual world based on the persona's location, wherein the initial description includes one or more sensory observations from the persona's location; receive, at the computing device, input for a directional movement of the persona within the virtual world; and responsive to the received input, output a subsequent description of the virtual world based on the persona's directional movement within the virtual world.

As another example, the subsequent description changes based on the specific directional movement associated with the received input. As another example, descriptions for each available directional movement are pre-assigned prior to the received input. As another example, the output initial description is generated from an LLM (large language model). In another example, the output subsequent description is likewise generated from the LLM. In a further example, the virtual world is a mix of user-created and LLM-created.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

1. A computing device, comprising:
one or more processors;
one or more hardware-based memory devices storing computer-executable instructions which, when executed by the one or more processors, cause the computing device to:
initiate an adventure in which a persona is placed within a virtual world;
output an initial description of the virtual world based on the persona's location, wherein the initial description includes one or more sensory observations from the persona's location;
receive, at the computing device, input for a directional movement of the persona within the virtual world; and
responsive to the received input, output a subsequent description of the virtual world based on the persona's directional movement within the virtual world.

2. The computing device of claim 1, wherein the subsequent description changes based on the specific directional movement associated with the received input.

3. The computing device of claim 1, wherein descriptions for each available directional movement are pre-assigned prior to the received input.

4. The computing device of claim 1, wherein the output initial description is generated from an LLM (large language model).

5. The computing device of claim 4, wherein the output subsequent description is likewise generated from the LLM.

6. The computing device of claim 1, wherein the virtual world is a mix of user-created and LLM-created.

7. The computing device of claim 1, wherein descriptions are directed to one or more of a human's senses.

8. A method performed by a computing device, comprising:
initiating an adventure in which a persona is placed within a virtual world;
outputting an initial description of the virtual world based on the persona's location, wherein the initial description includes one or more sensory observations from the persona's location;
receiving, at the computing device, input for a directional movement of the persona within the virtual world; and
responsive to the received input, outputting a subsequent description of the virtual world based on the persona's directional movement within the virtual world,
wherein the initial and subsequent descriptions are received at the computing device from a remote service.

9. The method of claim 8, wherein the subsequent description changes based on the specific directional movement associated with the received input.

10. The method of claim 8, wherein descriptions for each available directional movement are pre-assigned prior to the received input.

11. The method of claim 8, wherein the output initial description is generated from an LLM (large language model).

12. The method of claim 11, wherein the output subsequent description is likewise generated from the LLM.

13. The method of claim 8, wherein the virtual world is a mix of user-created and LLM-created.

14. The method of claim 8, wherein descriptions are directed to one or more of a human's senses.

15. One or more hardware-based non-transitory computer-readable memory devices storing computer-executable instructions which, when executed by one or more processors disposed in a computing device, causes the computing device to:
initiate an adventure in which a persona is placed within a virtual world;
output an initial description of the virtual world based on the persona's location, wherein the initial description includes one or more sensory observations from the persona's location;
receive, at the computing device, input for a directional movement of the persona within the virtual world; and
responsive to the received input, output a subsequent description of the virtual world based on the persona's directional movement within the virtual world.

16. The one or more hardware-based memory devices of claim 15, wherein the subsequent description changes based on the specific directional movement associated with the received input.

17. The one or more hardware-based memory devices of claim 15, wherein descriptions for each available directional movement are pre-assigned prior to the received input.

18. The one or more hardware-based memory devices of claim 15, wherein the output initial description is generated from an LLM (large language model).

19. The one or more hardware-based memory devices of claim 18, wherein the output subsequent description is likewise generated from the LLM.

20. The one or more hardware-based memory devices of claim 15, wherein the virtual world is a mix of user-created and LLM-created.
